(19) United States
(12) Patent Application Publication
(10) Pub. No.: US 2008/0231416 A1
(43) Pub. Date: Sep. 25, 2008

(54) LATENCY REDUCTION IN REMOTE SIGNAL COMMUNICATION SYSTEM

(75) Inventors: Brian Marlett, Macomb, MI (US); Patricia Kachouh, Sterling Heights, MI (US)

Correspondence Address: CARLSON, GASKEY & OLDS, P.C., 400 WEST MAPLE ROAD, SUITE 350, BIRMINGHAM, MI, 48009, US

(73) Assignee: Continental Automotive Systems US, Inc., Aubun Hills, MI (US)

(21) Appl. No.: 11/972,798

(22) Filed: Jan. 11, 2008

Related U.S. Application Data
(60) Provisional application No. 60/919,247, filed on Mar. 21, 2007.

(51) Int. Cl. G05B 19/00; B60R 25/10

(52) U.S. Cl. 340/5.1; 340/825.72; 340/426.13

(57) ABSTRACT

A method of operating a remote signal communication system to reduce entry latency includes the steps of remotely starting a vehicle, and periodically communicating a signal to a plurality of locations of the vehicle subsequent to starting the vehicle.

### CROSS-REFERENCE TO RELATED APPLICATIONS

This application claims priority to U.S. Provisional Application No. 60/919,247, filed Mar. 21, 2007.

### BACKGROUND OF THE INVENTION

This disclosure generally relates to remote signal communication systems, and more particularly to a method of reducing entry latency associated with a vehicle remote signal communication system.

A variety of remote signal communication systems are used in vehicles to authorize and perform desired functions remotely. Examples include remote keyless entry systems (RKE), passive start and entry systems (PASE) and remote start systems. Functions performed by these systems include, for example, unlocking of the motor vehicle and enabling the vehicle starting system without a mechanical key.

In a PASE system, for example, communication begins upon some physical prompt, such as actuation of a vehicle door handle. Upon this action, the vehicle module sends out a low frequency radio signal and then waits for a reply from a proximate authentication device, such as a key fob. The vehicle module next utilizes an encryption sequence to confirm the authenticity of the proximate authentication device.

One challenge facing designers of typical remote signal communication systems, such as PASE systems, is the latency associated with the systems. That is, the methods for authenticating and communicating signals between a receiver module and a proximate authentication device require time for the numerous calculations to be performed. In addition, the requirement of a physical prompt, such as actuation of a vehicle door handle, to begin the passive authentication process increases the potential wait times associated with entry to the vehicle. A relatively large amount of entry latency is unacceptable to customers.

One method for improving the latency of a remote signal communication system is to constantly ping a low frequency radio signal to the proximate authentication device. However, such a method places a relatively large load and current draw on the vehicle battery that is also unacceptable to the customer.

Accordingly, it is desirable to provide a remote signal communication system that reduces any perceived hesitation in system performance in a manner that has minimal effect on other systems of a vehicle.

### SUMMARY OF THE INVENTION

A method of reducing latency associated with a remote signal communication system includes remotely starting a vehicle, and periodically communicating a signal to a plurality of locations of the vehicle subsequent to starting the vehicle.

A method of operating a remote signal communication system includes communicating a remote start signal to a vehicle, starting the vehicle, periodically communicating a passive entry signal to a plurality of locations of the vehicle and authorizing entry to the vehicle.

A remote signal communication system for a vehicle includes a remote authentication device and a control unit. The remote authentication device includes a remote start switch. The control unit is positioned on the vehicle and is in selective communication with the remote authentication device. The control unit is operable to periodically communicate a signal to the remote authentication device in response to manipulation of the remote start switch.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic representation of an example remote signal communication system;

FIG. 2 is a schematic representation of an example control module of the remote signal communications system as illustrated in FIG. 1;

FIG. 3 is a block diagram of an example method of operating a remote signal communication system to reduce latency; and

FIG. 4 schematically illustrates the communication of a passive entry signal to a plurality of locations of a vehicle.

### DETAILED DESCRIPTION OF THE DISCLOSED EMBODIMENT

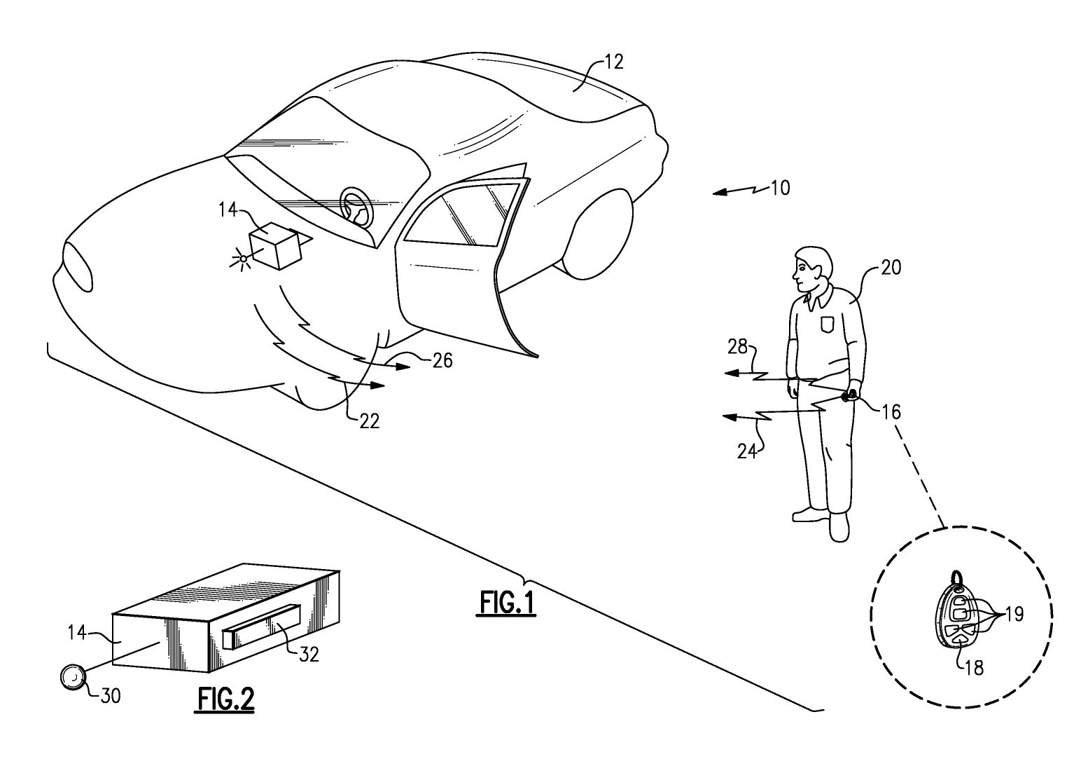

FIG. 1 illustrates an example remote signal communication system 10 of a vehicle 12. In this example, the remote signal communication system 10 includes a passive start and entry system (PASE) and a remote start system. Although the examples described within this disclosure relate to a remote signal communication system having PASE functionality and remote start functionality, it should be understood that the vehicle 12 may be equipped with any combination and number of remote signal communication systems.

The remote signal communication system 10 includes a control unit 14 and a proximate authentication device 16. In one example, the proximate authentication device 16 is a key fob. Although only one proximate authentication device 16 is illustrated, it should be understood that a plurality of proximate authentication devices 16 could be associated with the remote signal communication system 10.

The proximate authentication device 16 includes a remote start switch 18. Manipulation of the remote start switch 18 by a vehicle operator 20 provides for remote starting of the vehicle 12. That is, once the remote start switch 18 is manipulated, the vehicle 12 is running. In one example, the remote start switch 18 is manipulated by pressing the switch 18. Manipulation of the remote start switch 18 communicates a remote start signal to the control unit 14. The control unit 14 analyzes the remote start signal and, where the signal is valid, communicates a signal to start the vehicle 12. A person of ordinary skill in the art having the benefit of this disclosure would know how to implement the remote start system within the vehicle 12.

In addition to the remote start switch 18, the proximate authentication device 16 may also include a plurality of switches 19. The switches 19 are manipulated to perform other vehicle commands/functions, such as unlocking/locking a vehicle door, opening a trunk etc.

The remote signal communication system 10 also provides PASE functionality to allow access and operation of the vehicle 12 upon receipt and verification of signals between the control unit 14 and the proximate authentication device 16. Operation of the PASE system of the remote signal communication system 10 commences with the transmission of a first low frequency signal 22 from the control unit 14. The first low frequency signal 22 is communicated in response to a physical prompt, such as initial actuation of a door handle of the vehicle 12, for example. In one example, the door handle includes input triggers, such as a switch or a capacitative sensor, for example, for triggering the transmission of the first low frequency signal 22.

The first low frequency signal 22 is a challenge signal that requests a response from the proximate authentication device 16 at a proximate area of the vehicle, such as the vehicle door, for example. The proximate authentication device 16, if located at the proximate area, sends a response transmission 24 that includes an identification code or signal.

The control unit 14 utilizes the identification code that is unique to the proximate authentication device 16 to generate an encrypted portion of a second low frequency signal 26. The second low frequency signal 26 includes encrypted information that is uniquely crafted for the response from the proximate authentication device 16. In this example, the proximate authentication device 16 responds to the second low frequency signal 26 from the control unit 14 with a second RF signal 28. The second RF signal 28 includes a return encrypted portion to verify authenticity along with signals that communicate desired commands such as for unlocking the vehicle doors, or starting the vehicle, for example.

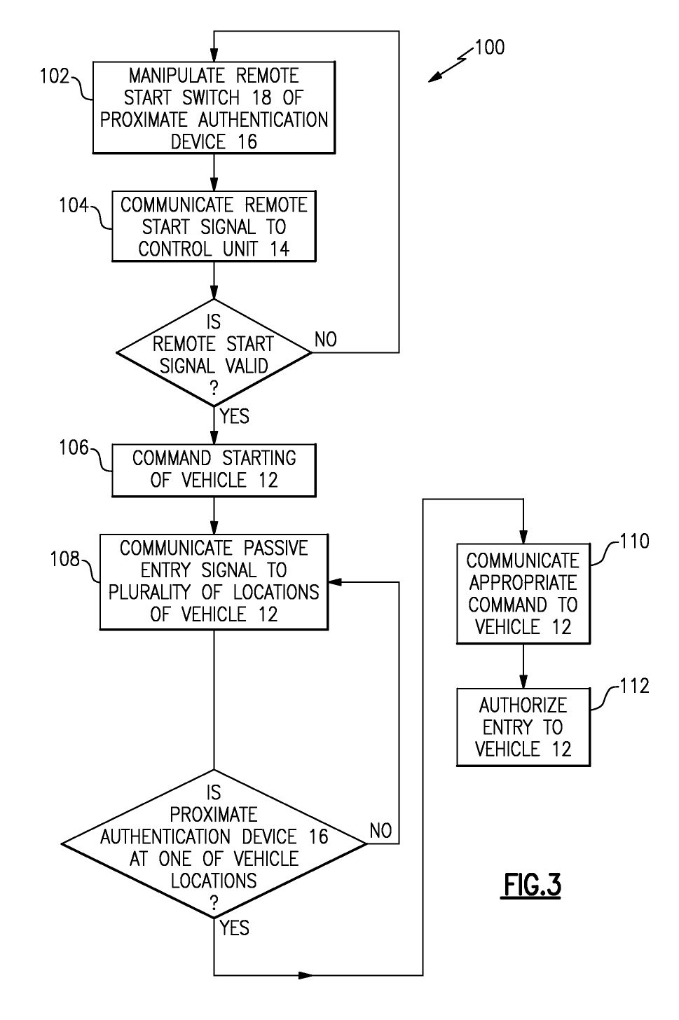

FIG. 2 schematically illustrates the control unit 14 of the remote signal communication system 10. The control unit 14 includes an antenna 30 for emitting and receiving signals along with a non-volatile memory location 32. It should be understood that the various hardware and software required by the control unit 14 to perform the functions of the remote signal communication system 10 are within the skill of a worker of ordinary skill in the art.

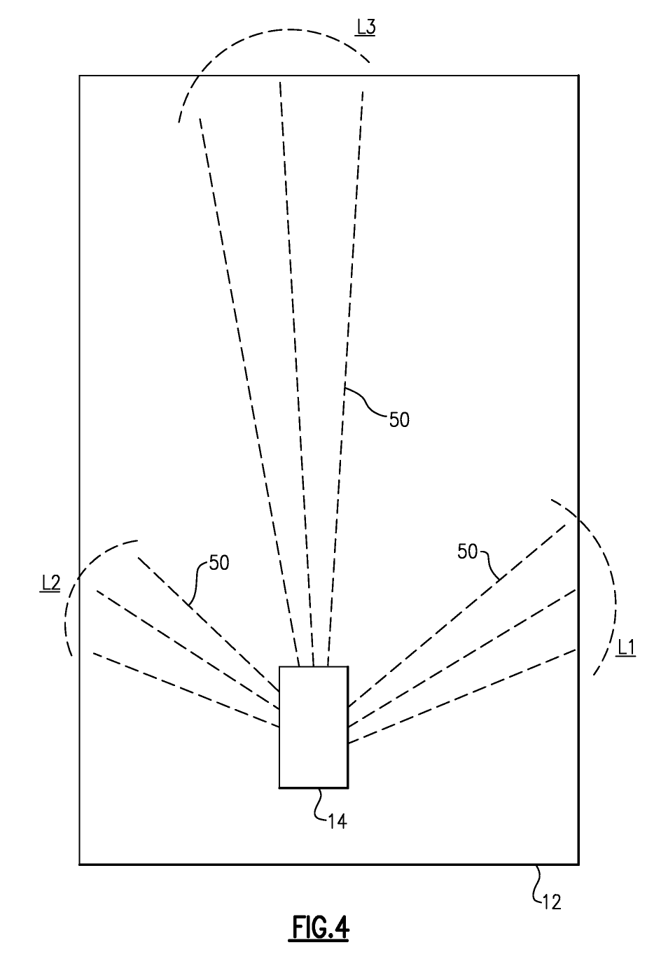

FIG. 3, with continuing reference to FIGS. 1 and 2, illustrates an example method 100 of operating the remote signal communication system 10. In one example, the method 100 operates to reduce any entry latency associated with the remote signal communication system 10. The method 100 begins at step block 102 where a vehicle operator 20 manipulates the remote start switch 18 of the proximate authentication device 16. At step block 104, a remote start signal is communicated to the control unit 14 of the vehicle 12 in response to manipulation of the remote start switch 18. In one example, the remote start signal is a radio frequency signal.

Next, at step block 106, the control unit 14 commands starting of the vehicle 12 in response to receiving a valid remote start signal. At step block 108, and only where a valid remote start signal is received by the control unit 14 and the vehicle has been started and is running, the control unit 14 periodically communicates a passive entry signal to a plurality of locations of the vehicle 12.

In one example, the control unit 14 communicates a passive entry signal 50 to each of locations L1 through L3 of the vehicle 12 (See FIG. 4). Location L1 represents the driver side front door, location L2 represents the passenger side front door, and L3 represents the vehicle trunk. It should be understood that the control unit 14 may be programmed to communicate a passive entry signal 50 to any location of the vehicle. In this example, the passive entry signal 50 communicated to the locations L1-L3 of the vehicle is a low frequency signal that represents a challenge prompt that requests a response from the proximate authentication device 16 if the proximate authentication device 16 is in the vicinity of one of the locations L1 through L3.

In one example, a passive entry signal 50 is communicated to each of the locations L1-L3 about once every 500 milli-seconds. It should be understood that the passive entry signals 50 could be communicated at any time interval and that a worker of ordinary skill in the art having the benefit of this disclosure would be able to select an appropriate time interval for communicating the passive entry signal 50.

Assuming the proximate authentication device 16 is in the general vicinity of one of the vehicle locations L1 through L3, the remote signal communication system 10 is operable to communicate the desired commands to unlock one of the vehicle doors, or open a trunk, for example, at step block 110. The passive entry signals are communicated only in response to starting and running of the vehicle 12 in this example. Finally, at step block 112, entry to the vehicle 12 is authorized at the location of the proximate authentication device 16 where a valid verification signal is received by the control unit 14 from the proximate authentication device 16.

By utilizing remote start and PASE functionality in conjunction with one another, the entry latency associated with the remote signal communication system 10 is improved by at least 50 milli-seconds. That is, because the control unit 14 periodically communicates a signal to a plurality of locations of the vehicle 12 in response to the engine being in a remote start mode, it is unnecessary to wait for a physical prompt, such as initial actuation of a door handle, to initiate PASE functionality. Therefore, the entry latency of the remote signal communication system is reduced by as much as 50 milli-seconds. In addition, because the example method 100 proposes the use of a periodic pinging approach only when the vehicle 12 is started through remote start functionality, there is no high current draw on the vehicle battery or other vehicle systems of the vehicle 12.

The foregoing description shall be interpreted as illustrative and not in any limiting sense. A worker of ordinary skill in the art would recognize that certain modifications would come within the scope of this invention. For that reason, the following claims should be studied to determine the true scope and content of this invention.

What is claimed is:

1. A method of operating a remote signal communication system to reduce entry latency, comprising the steps of:
a) remotely starting a vehicle; and
b) periodically communicating a signal to a plurality of locations of the vehicle subsequent to starting the vehicle at said step a).

2. The method as recited in claim 1, wherein said step a) comprises:
starting the vehicle in response to manipulating a switch of a proximate authentication device of the remote signal communication system.

3. The method as recited in claim 1, wherein the plurality of locations of the vehicle include at least one of a vehicle door and a vehicle trunk.

4. The method as recited in claim 1, wherein the signal is a low frequency radio signal.

5. The method as recited in claim 1, wherein the remote signal communication system includes a passive start and entry system and a remote start system.

6. A method of operating a remote signal communication system, comprising the steps of:
a) communicating a remote start signal to a vehicle;
b) starting the vehicle in response to receiving the remote start signal;
c) periodically communicating a passive entry signal to a plurality of locations of the vehicle subsequent to starting the vehicle; and
d) authorizing entry to the vehicle responsive to receiving a verification signal from a proximate authentication device.

7. The method as recited in claim 6, wherein said step a) includes the step of:
communicating the remote start signal in response to manipulating a switch of a proximate authentication device.

8. The method as recited in claim 6, wherein said step c) includes the step of:
verifying whether the proximate authentication device is in the vicinity of one of the plurality of locations of the vehicle; and
communicating the verification signal to a control unit in response to the proximate authentication device being located in the vicinity of one of the plurality of locations.

9. The method as recited in claim 8, wherein said step d) includes the step of:
authorizing entry to the vehicle at the location of the proximate authentication device.

10. A remote signal communication system for a vehicle, comprising:
a remote authentication device having a remote start switch; and
a control unit positioned on the vehicle and in selective communication with said remote authentication device, wherein said controller is operable to periodically communicate a signal to said remote authentication device in response to manipulation of said remote start switch.

11. The system as recited in claim 10, wherein said signal is a low frequency radio signal.

12. The system as recited in claim 10, wherein said control unit includes an antenna and a non-volatile memory device.

13. The system as recited in claim 10, wherein said signal is communicated about once every 500 milli-seconds.

14. The system as recited in claim 10, wherein said remote signal communication system includes a passive start and entry system and a remote start system.

15. The system as recited in claim 10, wherein said remote authentication device includes a plurality of switches.
